(19) United States
(12) Patent Application Publication
(10) Pub. No.: US 2022/0269686 A1
(43) Pub. Date: Aug. 25, 2022

(54) INTERPRETATION OF RESULTS OF A SEMANTIC QUERY OVER A STRUCTURED DATABASE

(71) Applicant: International Business Machines Corporation, Armonk, NY (US)

(72) Inventors: Rajesh Bordawekar, Westchester, NY (US); Apoorva Nitsure, Pittsburgh, PA (US)

(21) Appl. No.: 17/184,303

(22) Filed: Feb. 24, 2021

(51) Int. Cl. G06F 16/2457; G06F 16/2455; G06N 5/04; G06F 16/2453; G06F 11/34

(52) U.S. Cl. CPC G06F 16/24578; G06F 16/24564; G06N 5/045; G06F 16/2453; G06F 11/3409

(57) ABSTRACT

Systems, computer-implemented methods and/or computer program products to facilitate interpretation of a result of execution of a query over a structured database are provided. According to an embodiment, a system can comprise a memory that stores computer executable components and a processor that executes the computer executable components stored in the memory. The computer executable components can comprise a determination component that determines a result of execution of a query over a structured database. The computer executable components also can comprise an interpretation component that interprets data underlying the result of execution of the query to determine one or more reasons that the result is provided in response to the query.

### BACKGROUND

One or more embodiments described herein relate generally to interpretation of a result of execution of a query over a structured database, and more specifically, to interpretation of data underlying a result of execution of the query, to determine one or more bases for provision of the result.

The use of unique queries to search a database is commonplace both domestically and commercially in various industries. For example, unique databases can be constructed including structured or unstructured data related to medical history, financial backgrounds, purchase history, item availability and/or the like. These databases can be searched using various query types such as similarity, analogy, antonym, prediction, structured query language (SQL) cognitive intelligence and/or the like.

In one example, a structured database can include structured data including structured relational data related to a plurality of entities. This structured database can be typed, meaning that entities included therein can include data and/or subsets of data related to one or more entity types, such as classifications, categories and/or the like. The type of data itself alternatively and/or additionally can be varied, such as including dates, numbers, words, phrases, abbreviations and/or other text. Each entry, or row, can be represented by a unique primary key. In a related example, a typed relational database, having structured data, can be enhanced by using an unsupervised neural network and hence artificial intelligence powered (AI-powered). The AI-powered database can use semantic word vector representations of relational entities to enable one or more semantic queries, such as cognitive intelligence queries.

Upon execution of a cognitive intelligence query by a constituent, such as a machine, device, component, hardware, software or human, one or more results can be returned to the constituent. Depending on the query and/or the particular database, in one or more instances, a plurality of results can be ranked. In other instances, only one or more results can be returned, while others are not returned or are ignored.

Nonetheless, even though results can be provided, a problem associated with query execution approaches, such as cognitive intelligence query execution approaches, is that they are not supported with an ability to output information regarding interpretability of the particular results. In one example, a query execution approach can provide a constituent with a modeled approach mimicking the workings of the database in response to a query. However, such approach does not provide particular understanding as to particular hooks relative to a particular query to the constituent.

That is, current query execution approaches can be unable to provide the constituent with one or more bases for returning one or more particular results in response to execution of a unique query. In an example, a medical professional can make a test result query or a donor request query and be provided a test result or donor in response. However, this information can be only partially useful without a basis for the result being provided. In another example, a finance professional can make a query as to whether a transaction is allowable, however can receive a result lacking information regarding why the transaction was labeled accordingly, which information can be used to maintain compliance with one or more rules, laws or regulations. The inability of current query execution approaches, such as cognitive intelligence query execution approaches, to provide reasoning, such as one or more bases, for provision of the query results from a structured database can lead to mistrust of the returned results or database. Alternatively and/or additionally, this inability can result in inability to understand how to modify the respective query execution approach to provide results more closely related to a particular query and/or query type.

### SUMMARY

The following presents a summary to provide a basic understanding of one or more embodiments described herein. This summary is not intended to identify key or critical elements, or to delineate any scope of the particular embodiments or any scope of the claims. The sole purpose of the summary is to present concepts in a simplified form as a prelude to the more detailed description that is presented later. In one or more embodiments described herein, devices, systems, computer-implemented methods, apparatus and/or computer program products are described that can facilitate interpretation of a result of execution of a query over a structured database.

According to an embodiment, a system can comprise a memory that stores computer executable components and a processor that executes the computer executable components stored in the memory. The computer executable components can comprise a determination component that determines a result of execution of a query over a structured database. The computer executable components also can comprise an interpretation component that interprets data underlying the result of execution of the query to determine one or more reasons that the result is provided in response to the query.

According to another embodiment, a computer-implemented method can comprise determining, by a system operatively coupled to a processor, a result of execution of a query over a structured database. The computer-implemented method can further comprise interpreting, by the system, data underlying the result of execution of the query to determine one or more reasons that the result is provided in response to the query.

According to yet another embodiment, a computer program product for interpretation of a result of a query over a structured database can comprise a computer readable storage medium having program instructions embodied therewith. The program instructions can be executable by a processor to determine, by the processor, a result of execution of the query of the structured database. The program instructions also can be executable by a processor to interpret, by the processor, data underlying the result of execution of the query to determine one or more reasons that the result is provided in response to the query. An advantage of such system, computer program product and/or method can be that one or more bases having one or more reasons supporting the query result can be provided to the constituent, e.g., a machine, device, component, hardware, software or human Via having such support, a constituent can be aided in determining a quality of the query result, the query executed and/or the data over which execution was performed.

In one or more embodiments of the above system, computer program product and/or method, the structured database can comprise a typed relational database including information regarding a plurality of entity types, the query can be a semantic query, and/or the interpretation of the data can comprise inter- and intra-entity type analysis. In one or more embodiments of the above system, computer program product and/or method, the interpretation of the data can comprise one or both of a) calculation of a degree of uniqueness of a first aspect of structured data of the database as distinguished relative to one or more other aspects of structured data of the database and b) calculation of a degree of influence of an aspect of structured data of the database relative to the result of execution of the query. An advantage of such system, computer program product and/or method can be an increased understanding of the reasons supporting the query result, by allowing for comparing and/or contrasting various bases.

According to still another embodiment, a system can comprise a memory that stores computer executable components and a processor that executes the computer executable components stored in the memory. The computer executable components can comprise a determination component that determines a result of execution of a query over a structured database. The computer executable components also can comprise an interpretation component that calculates one or more numerical values for one or more aspects of the database, which one or more aspects have respective distinct relations to the result. An advantage of such system can be that one or more bases having one or more reasons supporting the query result can be provided to the constituent, e.g., a machine, device, component, hardware, software or human. Via having such support, a constituent can be aided in determining a quality of the query result, the query executed and/or the data over which execution was performed.

Further, the above system can include where the one or more numerical values are ranked relative to one or more other numerical values calculated for one or more other aspects of the database. An advantage of such system can be an increased understanding of the reasons supporting the query result, by allowing for comparing and/or contrasting various bases.

According to a further embodiment, a system can comprise a memory that stores computer executable components and a processor that executes the computer executable components stored in the memory. The computer executable components can comprise a determination component that determines a result of execution of a query over a database. The computer executable components also can comprise an interpretation component that interprets data underlying a result of execution of a query over the database, to determine a basis for the result. An advantage of such system can be that one or more bases having one or more reasons supporting the query result can be provided to the constituent, e.g., a machine, device, component, hardware, software or human Via having such support, a constituent can be aided in determining a quality of the query result, the query executed and/or the data over which execution was performed.

Further, the computer executable components can comprise an output component that outputs the basis as a numerical value where the numerical value represents a degree of influence or a degree of uniqueness of an aspect of data of the database relative to the result or to one or more other aspects of data of the database in respect to provision of the result. An advantage of such system can be an increased understanding of the reasons supporting the query result, by allowing for comparing and/or contrasting various bases.

### DESCRIPTION OF THE DRAWINGS

FIG. 1 illustrates a block diagram of an example, non-limiting system that facilitates interpretation of a result of execution of a query over a structured database, in accordance with one or more embodiments described herein.

FIG. 2 illustrates an alternative block diagram of the example, non-limiting system of FIG. 1, in accordance with one or more embodiments described herein.

FIG. 3 illustrates a continuation of the block diagram of the example, non-limiting system of FIG. 2, in accordance with one or more embodiments described herein.

FIG. 4 illustrates a block diagram of an example process performed by a non-limiting system that facilitates interpretation of a result of execution of a query over a structured database, in accordance with one or more embodiments described herein.

FIG. 5 illustrates a block diagram of an example process performed by a non-limiting system that facilitates interpretation of a result of execution of a query over a structured database, in accordance with one or more embodiments described herein.

FIG. 6 illustrates a block diagram of an example process performed by a non-limiting system that facilitates interpretation of a result of execution of a query over a structured database, in accordance with one or more embodiments described herein.

FIG. 7 illustrates a block diagram of an example process performed by a non-limiting system that facilitates interpretation of a result of execution of a query over a structured database, in accordance with one or more embodiments described herein.

FIG. 8 illustrates a block diagram of an example process performed by a non-limiting system that facilitates interpretation of a result of execution of a query over a structured database, in accordance with one or more embodiments described herein.

FIG. 9 illustrates a flow diagram of an example, non-limiting computer-implemented method that facilitates interpretation of a result of execution of a query over a structured database, in accordance with one or more embodiments described herein.

FIG. 10 illustrates a continuation of the flow diagram of FIG. 9, of an example, non-limiting computer-implemented method that facilitates interpretation of a result of execution of a query over a structured database, in accordance with one or more embodiments described herein.

FIG. 11 illustrates a block diagram of an example, non-limiting operating environment in which one or more embodiments described herein can be facilitated.

FIG. 12 illustrates a block diagram of an example, non-limiting cloud computing environment in accordance with one or more embodiments disclosed herein.

FIG. 13 illustrates a block diagram of a plurality of example, non-limiting abstraction model layers, in accordance with one or more embodiments disclosed herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in this Detailed Description section.

Given the aforementioned problems with understanding and/or receiving one or more bases for a given result of execution of a query, such as a cognitive intelligence query, one or more embodiments described herein can be implemented to provide a solution to one or more of these problems. The solution can be provided in the form of systems, computer-implemented methods and/or computer program products that can facilitate the following processes: a) execution of a query; b) determination of a result of execution of the query; c) interpretation of data underlying the result; d) quantifying one or more bases for the result; e) interfacing with a constituent to provide the one or more bases; and/or f) optimizing the result of execution of the query and/or of subsequent queries.

In one or more examples, interpretation of data underlying a result of execution of a query can include: i) provision of data related to explaining the underlying vectors; ii) calculating one or more numerical values for one or more aspects of the database; iii) ranking the one or more numerical values relative to one or more other numerical values calculated for one or more other aspects of the database; iv) computing contributions of individual and/or collective neighboring data aspects of the database; v) computing a degree of influence or uniqueness of an aspect of the database; and/or vi) comparing one or more computed numerical values to one or more other numerical values and/or to a query result. In one or more examples, optimizing the result of execution of a query can generally include improving performance and/or quality of query results. This can include: i) providing resolution for an incorrect value of the query result, ii) providing a result more closely related to a particular query and/or query type and/or iii) determining key database statistics providing greater contribution to results than other database statistics relative to a query type.

That is, one or more embodiments described herein include one or more systems, computer-implemented methods, apparatuses and/or computer program products that can facilitate one or more of the aforementioned processes. One advantage of the one or more systems, computer-implemented methods and/or computer program products can be the ability to automatically query a structured database, and do so relative to continually updated data and relationships comprised by the structured database. Another advantage of the one or more systems, computer-implemented methods, apparatuses and/or computer program products can be the ability to automatically review and/or analyze the voluminous amounts of new content continually added to public and non-public databases. Yet another advantage of the one or more systems, computer-implemented methods, apparatuses and/or computer program products can be the ability to automatically provide insight to the user/constituent via an open box approach, that is, providing one or more bases for results of execution of a query. This can result in an increased interpretability of query results. Via the increased interpretability, the query result interpretation system can allow for optimization of the query result interpretation system through one or more automatic and/or selectively applied optimizations of the search query, the query results, future queries and/or results of future queries.

One or more embodiments are now described with reference to the drawings, where like referenced numerals are used to refer to like elements throughout. In the following description, for purposes of explanation, one or more specific details are set forth in order to provide a more thorough understanding of the one or more embodiments. It is evident in various cases, however, that the one or more embodiments can be practiced without these specific details.

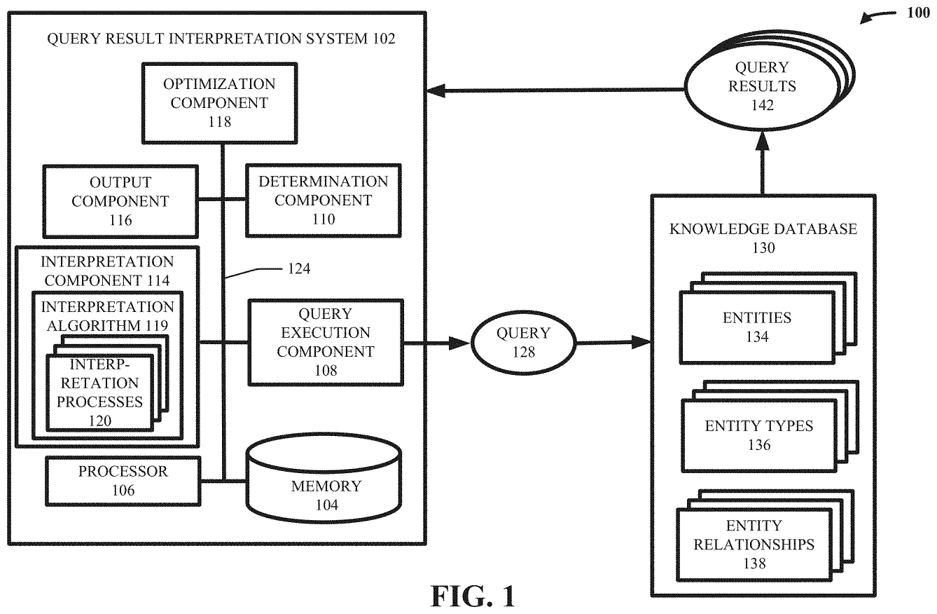

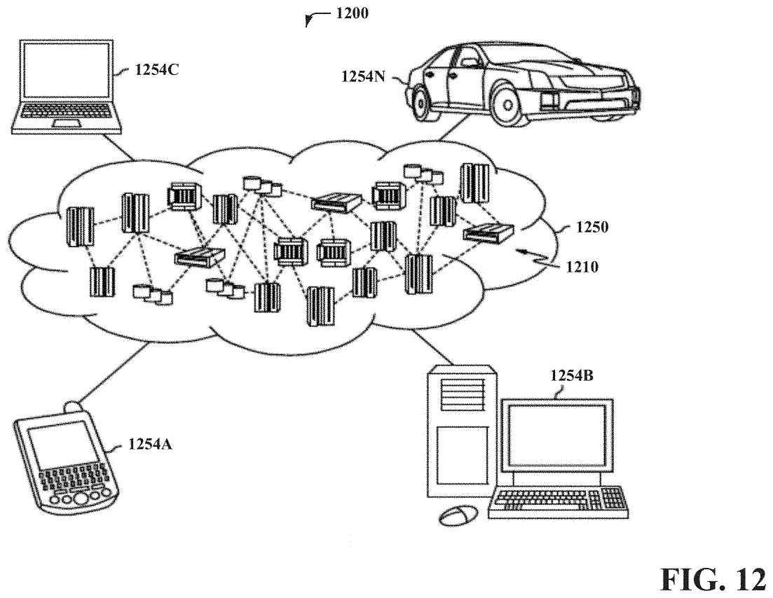

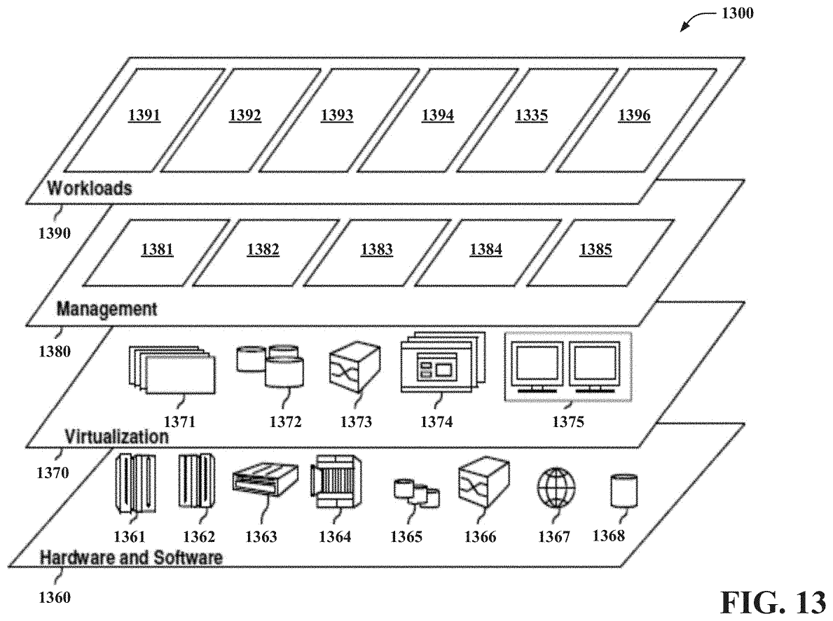

Turning now in particular to one or more figures, and first to FIG. 1, the figure illustrates a block diagram of an example, non-limiting system 100 that facilitates interpretation of a result of execution of a query over a structured database in accordance with one or more embodiments described herein. The non-limiting system 100 can comprise a query result interpretation system 102, which can be associated with a cloud computing environment. For example, the query result interpretation system 102 can be associated with a cloud computing environment 1250 described below with reference to FIG. 12 and/or with one or more functional abstraction layers described below with reference to FIG. 13 (e.g., hardware and software layer 1360, virtualization layer 1370, management layer 1380 and/or workloads layer 1390).

Query result interpretation system 102 and/or components thereof (e.g., determination component 110, interpretation component 114, output component 116 and/or optimization component 118) can employ one or more computing resources of the cloud computing environment 1250 described below with reference to FIG. 12, and/or with reference to the one or more functional abstraction layers (e.g., quantum software and/or the like) described below with reference to FIG. 13, to execute one or more operations in accordance with one or more embodiments described herein. For example, cloud computing environment 1250 and/or one or more of the functional abstraction layers 1360, 1370, 1380 and/or 1390 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by query result interpretation system 102 and/or components thereof to execute one or more operations in accordance with one or more embodiments described herein. For instance, query result interpretation system 102 and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or another operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and services) that can be rapidly provisioned and released with minimal management effort or interaction with a provider of the service. This cloud model can include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but can be able to specify location at a higher level of abstraction (e.g., country, state or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at some level of abstraction appropriate to the type of service (e.g., storage, processing, bandwidth and active user accounts). Resource usage can be monitored, controlled and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

### Deployment Models are as Follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting system 100 can be associated with or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system or the like. In accordance therewith, the non-limiting system 100 can be employed to use hardware and/or software to solve problems that are highly technical in nature, that are not abstract and/or that cannot be performed as a set of mental acts by a human.

Turning now to aspects of query result interpretation system 102, comprised can be a memory 104, a processor 106, a determination component 110, an interpretation component 114 and/or an output component 116. Query result interpretation system 102 also can comprise a query execution component 108 and an optimization component 118.

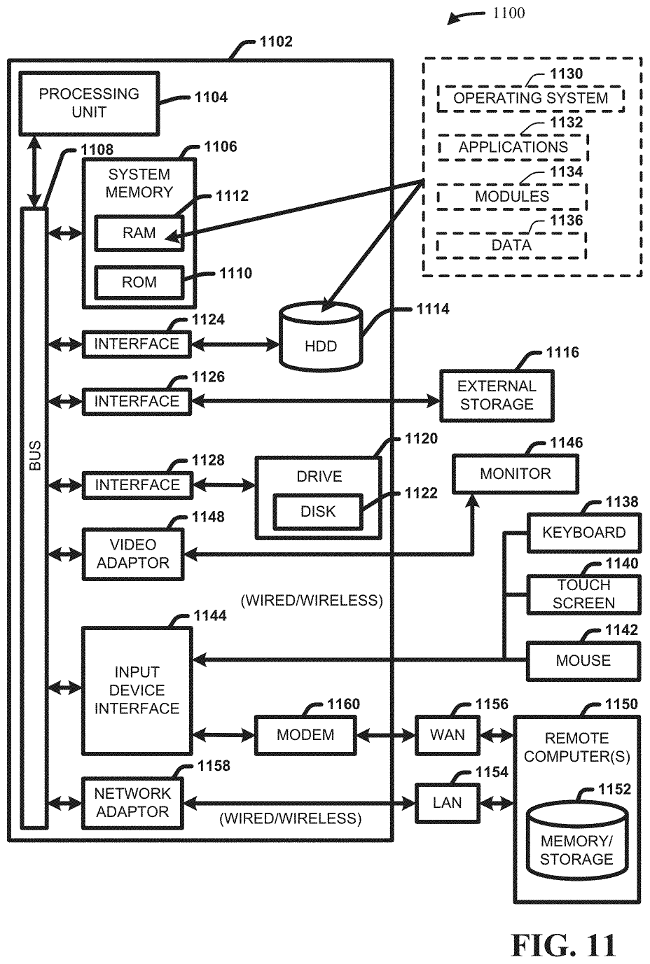

It should be appreciated that the embodiments depicted in various figures disclosed herein are for illustration only, and as such, the architecture of embodiments is not limited to the systems, devices and/or components depicted therein, nor to any particular order, connection and/or coupling of systems, devices and/or components depicted therein. For example, in one or more embodiments, non-limiting system 100 and/or query result interpretation system 102 can further comprise various computer and/or computing-based elements described herein with reference to operating environment 1100 and FIG. 11. In several embodiments, computer and/or computing-based elements can be used in connection with implementing one or more of the systems, devices, components and/or computer-implemented operations shown and described in connection with FIG. 1 or with other figures disclosed herein.

Memory 104 can store one or more computer and/or machine readable, writable and/or executable components and/or instructions that, when executed by processor 106 (e.g., a classical processor, a quantum processor and/or like processor), can facilitate performance of operations defined by the executable component(s) and/or instruction(s). For example, memory 104 can store computer and/or machine readable, writable and/or executable components and/or instructions that, when executed by processor 106, can facilitate execution of the various functions described herein relating to query result interpretation system 102, determination component 110, interpretation component 114, output component 116, optimization component 118 and/or another component associated with query result interpretation system 102 as described herein with or without reference to the various figures of the one or more embodiments.

Memory 104 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures. Further examples of memory 104 are described below with reference to system memory 1106 and FIG. 11. These examples of memory 104 can be employed to implement any one or more embodiments described herein.

Processor 106 can comprise one or more types of processors and/or electronic circuitry (e.g., a classical processor, a quantum processor and/or like processor) that can implement one or more computer and/or machine readable, writable and/or executable components and/or instructions that can be stored at memory 104. For example, processor 106 can perform various operations that can be specified by computer and/or machine readable, writable and/or executable components and/or instructions including, but not limited to, logic, control, input/output (I/O), arithmetic and/or the like. In one or more embodiments, processor 106 can comprise one or more central processing unit, multi-core processor, microprocessor, dual microprocessors, microcontroller, System on a Chip (SOC), array processor, vector processor, quantum processor and/or another type of processor. Additional examples of processor 106 are described below with reference to processing unit 1104 and FIG. 11. The examples of processor 106 can be employed to implement any one or more embodiments described herein.

Query result interpretation system 102, memory 104, processor 106, determination component 110, interpretation component 114, output component 116, optimization component 118 and/or another component of query result interpretation system 102 as described herein can be communicatively, electrically, operatively and/or optically coupled to one another via a bus 124 to perform functions of the non-limiting system 100, query result interpretation system 102 and/or any components coupled therewith. Bus 124 can comprise one or more memory bus, memory controller, peripheral bus, external bus, local bus, a quantum bus and/or another type of bus that can employ various bus architectures. Further examples of bus 124 are described below with reference to system bus 1108 and FIG. 11. The examples of bus 124 can be employed to implement any one or more embodiments described herein.

Query result interpretation system 102 can comprise any type of component, machine, device, facility, apparatus and/or instrument that comprises a processor and/or can be capable of effective and/or operative communication with a wired and/or wireless network. All such embodiments are envisioned. For example, query result interpretation system 102 can comprise a server device, a computing device, a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players and/or another type of device.

Query result interpretation system 102 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like). In one or more embodiments, query result interpretation system 102 can be coupled (e.g., communicatively, electrically, operatively, optically and/or like function) to one or more external systems, sources and/or devices (e.g., classical and/or quantum computing devices, communication devices and/or like devices) via a network.

In one or more embodiments, a network can comprise one or more wired and/or wireless networks, including, but not limited to, a cellular network, a wide area network (WAN) (e.g., the Internet), or a local area network (LAN). For example, query result interpretation system 102 can communicate with one or more external systems, sources and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, query result interpretation system 102 can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and software that facilitates communicating information among query result interpretation system 102 and external systems, sources and/or devices (e.g., computing devices, communication devices and/or the like).

Query result interpretation system 102 can comprise one or more computer and/or machine readable, writable and/or executable components and/or instructions that, when executed by processor 106 (e.g., a classical processor, a quantum processor and/or like processor), can facilitate performance of one or more operations defined by such component(s) and/or instruction(s). Further, in one or more embodiments, any component associated with query result interpretation system 102, as described herein with or without reference to the various figures of the one or more embodiments, can comprise one or more computer and/or machine readable, writable and/or executable components and/or instructions that, when executed by processor 106, can facilitate performance of one or more operations defined by such component(s) and/or instruction(s). For example, determination component 110, interpretation component 114, output component 116, optimization component 118 and/or any other components associated with query result interpretation system 102 as disclosed herein (e.g., communicatively, electronically, operatively and/or optically coupled with and/or employed by query result interpretation system 102), can comprise such computer and/or machine readable, writable and/or executable component(s) and/or instruction(s). Consequently, according to one or more embodiments described herein, query result interpretation system 102 and/or any components associated therewith as disclosed herein, can employ processor 106 to execute such computer and/or machine readable, writable and/or executable component(s) and/or instruction(s) to facilitate performance of one or more operations described herein with reference to query result interpretation system 102 and/or any such components associated therewith.

Query result interpretation system 102 can facilitate (e.g., via processor 106) performance of operations executed by and/or associated with determination component 110, interpretation component 114, output component 116, optimization component 118 and/or another component associated with query result interpretation system 102 as disclosed herein. For instance, as described in detail below, query result interpretation system 102 can facilitate via processor 106 (e.g., a classical processor, a quantum processor and/or like processor): execution of a query 128 over a knowledge database 130; determination of a query result 142 of the execution; interpretation of data underlying the query result 142; determination of one or more outputs quantifying one or more bases for the query result 142; interfacing with a constituent to provide the one or more outputs; and/or optimizing the query result 142 of the execution of the query 128, the query 128 itself, a subsequent query and/or a result of a subsequent query.

In one or more examples, the interpretation of data underlying the query result 142 can include calculating one or more numerical values for one or more aspects of the knowledge database 130, ranking the one or more numerical values relative to one or more other numerical values calculated for one or more other data aspects of the knowledge database 130, computing contributions of individual and/or collective neighboring data aspects, such as tokens, of the knowledge database 130, and/or computing a degree of influence or uniqueness of an aspect of data of the knowledge database 130. In such examples, an aspect of data of the knowledge database 130 can be an entity 134, an entity type 136 and/or an entity relationship 138, which entity relationship 138 can be represented by a vector and/or the like.

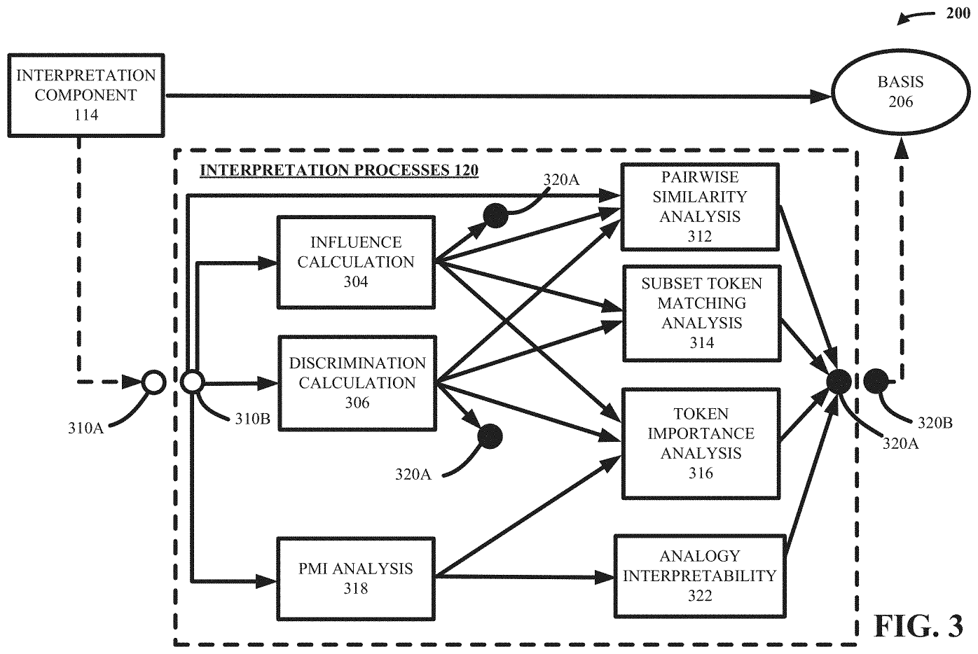

In one or more examples, as described in detail below, the query result interpretation system 102 can further facilitate via processor 106 (e.g., a classical processor, a quantum processor and/or like processor) applying one or more interpretation processes 120 to the query result 142. With brief reference to FIG. 3, these processes can include one or more influence calculations 304 and/or one or more discrimination calculations 306, to be described below in detail. The influence calculation 304 and/or discrimination calculation 306 can be employed to conduct additional interpretation processes 120, such as pairwise similarity analysis 312, subset token matching analysis 314, token importance analysis 316 for a prediction query and/or point-wise mutual information (PMI) analysis 318, also to be described below. In brief, these interpretation processes 120 each can be conducted utilizing data, such as structured data, from the knowledge database 130 (e.g., entities 134, entity types 136 and/or entity relationships 138), data generated during the query 128 over the knowledge database 130 (e.g., transformed data such as a calculation, percentage, ranking and/or other numerical value) and/or data input by a constituent (e.g., a threshold, an aspect of data to ignore or to elevate and/or other constituent-inputted parameter).

In one or more examples, as described in detail below, an advantage of the query result interpretation system 102 can be to further facilitate via processor 106 (e.g., a classical processor, a quantum processor and/or like processor) optimizing the query result 142 of execution of the query 128 to improve quality of query results 142. This improvement of quality can include providing entity resolution for an incorrect value of the query result 142, providing a query result 142 more closely related to a particular query 128 or query type, determining key database statistics providing greater contribution to results than other database statistics and/or modifying how one or more data aspects (e.g., entities 134, entity types 136 and/or entity relationships 138), are utilized to provide one or more query results.

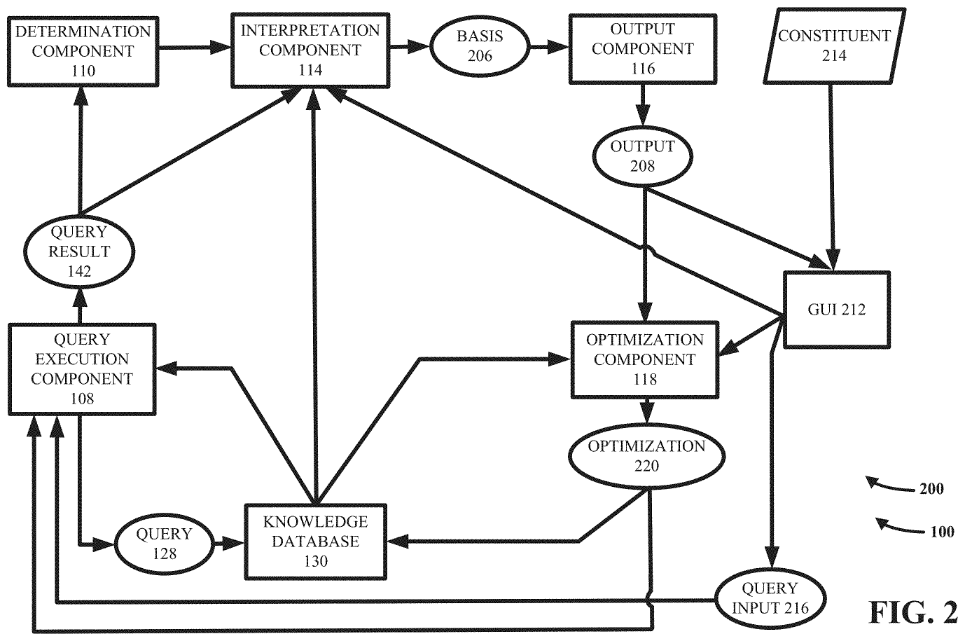

Turning now to additional aspects illustrated at FIG. 1, such as the components of the query result interpretation system 102 as illustrated in FIG. 1, further functionality of the query result interpretation system 102 will be described. Additional description of functionalities will be further described below with reference to the example embodiment of FIGS. 2 and 3, where repetitive description of like elements and/or processes employed is omitted for sake of brevity.

Looking first to the query execution component 108, a query 128 can be executed in response to an input from a constituent, such as a machine, device, component, hardware, software or human. For example, a human user can input a cognitive intelligence query into a constituent interface, such as via a GUI, such as: “Will the customer default on their loan?”; “Where will the customer be most likely to shop again?” or “Is the patient susceptible to early-onset diabetes?”. These types of queries can employ data from the knowledge database 130 including various entities 134, entity types 136 associated with each entity 134 and/or entity relationships 138, including entity relationships among the entities 134, among the entity types 136 and/or among one or more entities 134 and one or more entity types 136. Execution of the query 128 can utilize any suitable software and/or hardware, such as related to the query result interpretation system 102 and/or related independently to the knowledge database 130, such as located at a server or other constituent comprising the knowledge database 130. Execution of a query is appreciated as being well understood by one having ordinary skill in the art and thus is not discussed herein, for sake of brevity. However, it still will be appreciated that execution of the query can be lacking in that a reasoning, such as one or more bases, is not provided by the standard query execution of current systems, devices, machines, computer program products, methods, and/or the like.

A solution to this problem can be at least partially facilitated by the determination component 110 and interpretation component 114 of one or more embodiments described herein. These one or more embodiments describe one or more processes for facilitating the provision of one or more bases based upon data underlying the one or more query results of execution of a query.

The following description refers to the interpretation of a single query result 142 from a single query 128. However, it will be appreciated that the processes described herein can be scalable. For example, the determination component 110 and interpretation component 114 can determine and interpret simultaneously, subsequently and/or in any suitable order, a plurality of query results 142 of execution of one or more queries 128.

Turning now to the determination component 110, the query result interpretation system 102, via the determination component 110, can employ any one or more aspects of an operating environment, such as the operating environment 1100 (FIG. 11), to determine (e.g., locate, receive or load) one or more query results 142 from a query 128 over one or more databases, such as over the knowledge database 130. By way of a non-limiting example referencing the operating environment 1100, a query result 142 can be loaded from the HDD 1114, received and/or retrieved from the memory/storage 1152 via the WAN 1156 and/or downloaded via the WAN 1156 from a node, such as a cloud computing node 1210 of a cloud computing environment 1250 (FIG. 12).

Once a query result 142 is determined, the interpretation component 114 can interpret data underlying the query result 142 to determine one or more bases for the query result 142. The interpretation component 114 can perform one or more interpretation processes 120 over the database employed for the query 128, such as the knowledge database 130. For example, the interpretation component 114 can run an interpretation algorithm 119 including one or more instructions for performing the one or more interpretation processes 120 and employing the one or more knowledge databases 130. It will be appreciated that the interpretation algorithm 119 and/or instructions for implementing the interpretation algorithm 119, can be stored at the interpretation component 114, memory 104, and/or an external memory/storage, accessible via an associated cloud computing environment and/or the like.

Generally, the interpretation algorithm 119 can employ one or more of at least five kinds of auxiliary information relative to the query results 142 to provide to the constituent the one or more bases for the query result 142. These kinds of information can include: i) raw data statistics determined from the relevant one or more knowledge databases 130, ii) data from the one or more knowledge databases 130 converted in response to execution of the query 128, iii) constituent-selected inputs, iv) data from the one or more knowledge databases 130 converted via the one or more interpretation processes 120 (e.g., for use in other ones and/or repeat performance of the interpretation processes 120) and/or one or more vectors, such as word vectors, generated from the one or more knowledge databases 130.

First, raw statistics can include varying types of data, such as text, numbers, dates and/or the like. This is the raw structured data comprised by the knowledge database 130. Second, a query 128 can return other than a simple selection from the entities 134, entity types 136 and/or entity relationships 138 comprised by the knowledge database 130. That is, a cognitive query 128 executed by the query execution component 108 can return responses such as yes, no, lists, ranks, percentages and/or like predictions that are not explicitly provided in the base data of the knowledge database 130.

Third, regarding the constituent-selected inputs, one or more constituents can provide one or more parameters affecting the query result 142 of the query 128. These parameters can be input by the constituent(s), such as via the query execution component 108, such as using a GUI 212 (see, e.g., FIG. 2). The parameters can include identifying one or more aspects of a respective knowledge database 130 having greater influence and/or as having greater discrimination (e.g., uniqueness) relative to other aspects of the respective database. For example, a calculated influence parameter, i.e., an influence score, can capture the degree of impact for a column of data; a calculated discriminator parameter, i.e., discriminator score, can capture a degree of uniqueness where a column having many non-repeated values can be suited to distinguish corresponding rows of the respective knowledge database 130.

Further, the parameters can include setting one or more upper and/or lower thresholds for influence, for discrimination and/or for use of any aspect of data employed for an interpretation process 120, which are described in detail below. One or more aspects of data of the knowledge database 130 can be ignored, including one or more NULL values. Alternatively and/or additionally, one or more of these parameters can be effected relative to all other aspects of data of the knowledge database 130 and/or with respect to less than all other aspects of data of the knowledge database 130, such as one or more groups of aspects of data.

Fourth, another kind of information can be that provided via the one or more interpretation processes 120. Briefly, the interpretation process 120, each explained in detail below with reference to FIG. 3, can include an influence calculation, a discrimination calculation, a PMI analysis, pairwise similarity analysis, a subset token matching analysis and/or a prediction of token importance analysis.

Last, the one or more vectors generated by the one or more knowledge databases 130, such as word vectors generated by an AI-powered database, can be utilized in one or more interpretation processes 120 performed by the interpretation component 114. For example, a cosine similarity can be calculated between individual values of data of a knowledge database 130 for a pairwise similarity analysis, to be discussed below in detail.

Using the aforementioned kinds of auxiliary information, the interpretation component 114 can provide, via the output component 116, numerous types of analyzed information to the constituent regarding the one or more bases for the particular query result 142 returned in response to the query 128. These types can include numbers, percentages, rankings and/or the like. For example, referring still to FIG. 1, the output component 116 can output a basis determined by the interpretation component 114 as a numerical value output. The numerical value can be used by the constituent to better understand why the particular query result 142 was received. For example, the numerical value can be a normalized ranking between 0 and 1 for the influence of a particular entity 134 or entity type 136. Further, numerical values can be provided for one or more aspects of data of the database, such as entities 134, entity types 136 and/or entity relationships 138. The values can be ranked, such as via level of influence, discrimination, similarity and/or the like. These are all provided as examples that will be understood by one having ordinary skill in the art in relation to one or more interpretation processes 120 described below in detail with reference to FIG. 3.

In an example, a user of an AI-powered knowledge database can be looking to target certain customers like Customer X with certain promotional offers. A similarity query can be executed to answer the question: What are the top three customers similar to Customer X?”. The query results will thus include different customers similar to Customer X. In such case, the interpretation component 114 can provide one or more bases for why the particular query results were provided, in addition to one or more bases for a particular ranking of the query results provided via execution of the query. Particularly, one or more factors can be identified by the identification component as having a greater contribution to the result set and/or the ranking as compared to one or more other factors.

In an example, the output component 116 can generate a graphical user interface (GUI) to interface with a live constituent, such as a human The GUI can provide any one or more visual, audio and/or tactile feedbacks to the live constituent, such as via a monitor 1146, touch screen 1140 and/or one or more audio peripherals, with reference to the operating environment 1100 of FIG. 11. Further, the live constituent can interact with the GUI, such as via a keyboard 1138, touch screen 1140 and/or mouse 1142, again with reference to the operating environment 1100. The GUI can be generated to include one or more particular areas for visualizing the one or more bases for the query result 142. For example, separate outputs, if applicable, can be separately listed as influence calculation, a discrimination calculation, a PMI analysis, a pairwise similarity analysis, a subset token matching analysis and/or a prediction of token importance analysis. One or more definitions can be accessed via the GUI for helping the live constituent understand the meaning, calculation, use and/or purpose of one or more of these calculations.

Additionally and/or alternatively, the optimization component 118 can employ the one or more bases to enable optimization of the query result 142, query 128 and/or a future query and/or query result. Examples of these optimizations include, but are in no way limited to, providing entity resolution for an incorrect value of the query result 142, providing a query result 142 more closely related to a particular query 128 or query type, determining key database statistics providing greater contribution to results than other database statistics and/or modifying how one or more data aspects (e.g., entities 134, entity types 136 and/or entity relationships 138), are utilized to provide one or more query results 142. In one example, a constituent, such as via the output GUI, can correct and/or modify an incorrect query result 142, such as located in a query result database having one or more query results 142. In connection with correction and/or modification of the respective query result, the constituent can access the knowledge database 130, such as via the optimization component 118, to provide one or more parameters for the particular query 128, query type (e.g., similarity, cognitive intelligence and/or the like) and/or directly modify the knowledge database 130. In this way, future query results 142 and/or queries 128 can thus be modified, therefore providing process improvement of the query result interpretation system 102 itself.

Further, it will be appreciated that the processes discussed above as being performed by one or more of the components of the query result interpretation system 102 additionally and/or alternatively can be performed by one or more alternative components in one or more embodiments. That is, the software and/or hardware comprised and/or utilized by any one or more component of the query result interpretation system 102 can instead be comprised and/or utilized by a different one or more components of a respective alternative embodiment of the query result interpretation system 102.

Turning next to FIGS. 2 and 3, an alternative illustration of the non-limiting system 100 of FIG. 1 is illustrated. Repetitive description of like elements and/or processes employed in the embodiment of FIG. 1 is omitted for sake of brevity.

Looking first to FIG. 2, the figure illustrates a diagram 200 of the example, non-limiting system 100 (FIG. 1) that can facilitate interpretation of a result of execution of a query 128 over a structured database, such as the knowledge database 130.

Turning first to the execution of a query 128, a constituent 214, such as via a GUI 212, can provide a query input 216 to the query execution component 108 to cause the query 128 to be executed over the knowledge database 130. Data can be returned to, retrieved by and/or received by the query execution component 108, in response to the query 128. A query result 142 can be provided by the query execution component 108. The query result 142 can be determined, as described above, by the determination component 110. Alternatively and/or additionally, the query result 142 can be used by the interpretation component 114, when evaluating data underlying the query result 142. The interpretation component 114 alternatively and/or additionally can analyze the data in the structured knowledge database 130. Employing the data underlying the query result 142 and the data in the structured knowledge database 130, the interpretation component 114, such as via the interpretation algorithm 119, can provide one or more bases 206 providing one or more reasons why the particular query result 142 resulted from the particular query 128 over the particular knowledge database 130.

That is, turning now also to FIG. 3, in addition to FIG. 2, the interpretation component 114 can perform one or more interpretation processes 120 to thereby provide the one or more bases 206. FIG. 3 illustrates a portion of the diagram 200 with reference to FIG. 2, i.e., the provision of the basis 206 by the interpretation component 114. That is, FIG. 3 illustrates one or more examples exemplifying how the basis 206 is provided by the interpretation component 114. For purposes of clearer illustration, it is noted that connection node 310A passes to connection node 310B. Likewise, each connection node 320A passes to connection node 320B.

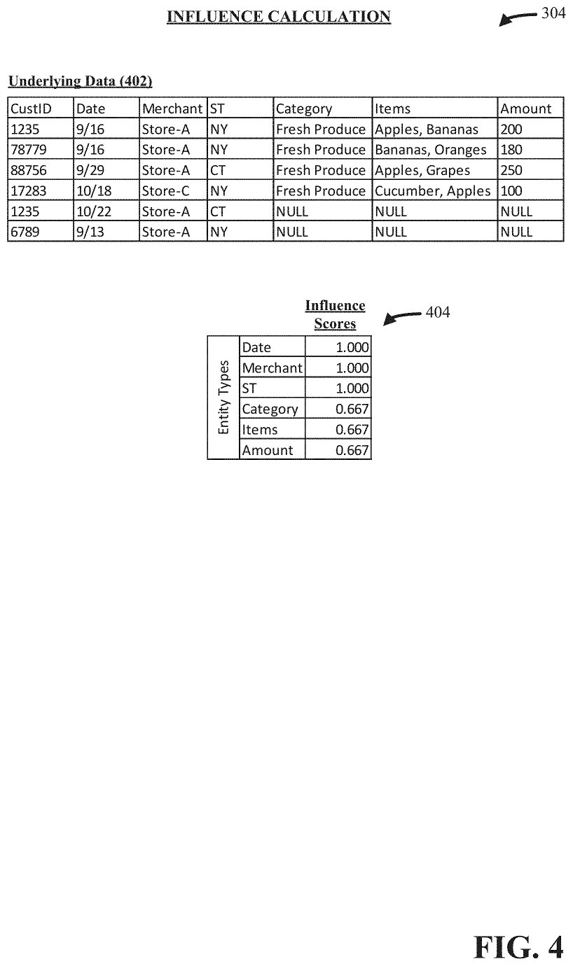

Turning now in addition to FIGS. 4 to 8, in addition to FIGS. 2 and 3, tabled diagrams of the one or more example interpretation processes 120 are illustrated which can be employed for facilitating interpretation by the interpretation component 114 of a query result 142 of execution of a query 128 over a structured database, such as the knowledge database 130.

Each of the diagrams of FIGS. 4 to 8 is illustrated with reference to a common set of structured data having a plurality of customer IDs (CustIDs), dates of shopping, merchants shopped, state (ST) of the merchant, category of product purchased, items purchased, and total amount (i.e., quantity) of items purchased. That is, the same data is employed for each of the one or more interpretation processes 120 illustrated at FIGS. 4-8, with each figure illustrating a different exemplary interpretation process 120. Units of product are not used for sake of brevity. With respect to the items purchased and/or any other data aspect, the knowledge database 130 can comprise comma delimited values, words and/or other text. In alternative knowledge databases, data can be presented in phrases, sentences, n-grams and/or the like. Further, repetitive description of like elements and/or processes employed in the embodiment of FIGS. 1 to 3 is omitted for sake of brevity.

Looking to FIGS. 3 and 4, the interpretation component 114, such as via the interpretation algorithm 119, can perform an influence calculation 304 on the data underlying the query result from the respective knowledge database. An advantage of the interpretation of the underlying data comprising the influence calculation 304 is that the influence calculation 304 aids in identifying influential entities or entity types, having influence on the query results 142. That is, this influence calculation 304 provides a normalized representation of the quantity of NULL values in a given column of the structured data underlying the query result. For example, the influence calculation 304 can capture the influence of an entity type, displayed here as a relational column, as a measure of the number of NULL values in the relational column. The NULL values do not contribute to the surrounding or neighboring data. That is, the influence score resulting from the influence calculation 304 is a numerical value having an inverse relationship to the number of individual values in a row or column that lack a related vector relationship.

Raw data is presented at table 402. For each entity type, the influence score is calculated according to the following:

$$influence score = 1 - \frac{\# ( NULL values in the column )}{\# ( total individual values in that column )} . \qquad Eq . 1$$

In a case where the #(NULL values in the column) matches the #(total individual values in that column), the influence score is 1-(#/#)=0. The influence score can vary from 1.000, meaning the column has the most influence and comprises no NULL values, to 0.000, meaning the column has very little or no influence and comprises all NULL values.

With respect to the table 402, the influence score can be calculated within one or more columns For example, at table 404, the entity types Date, Merchant and ST each have an influence score of 1.000 due to having no NULL values in their respective columns. Alternatively, the entity types Category, Items and Amount each have a lower influence score of 0.333 due to having two NULL values in each of their respective columns.

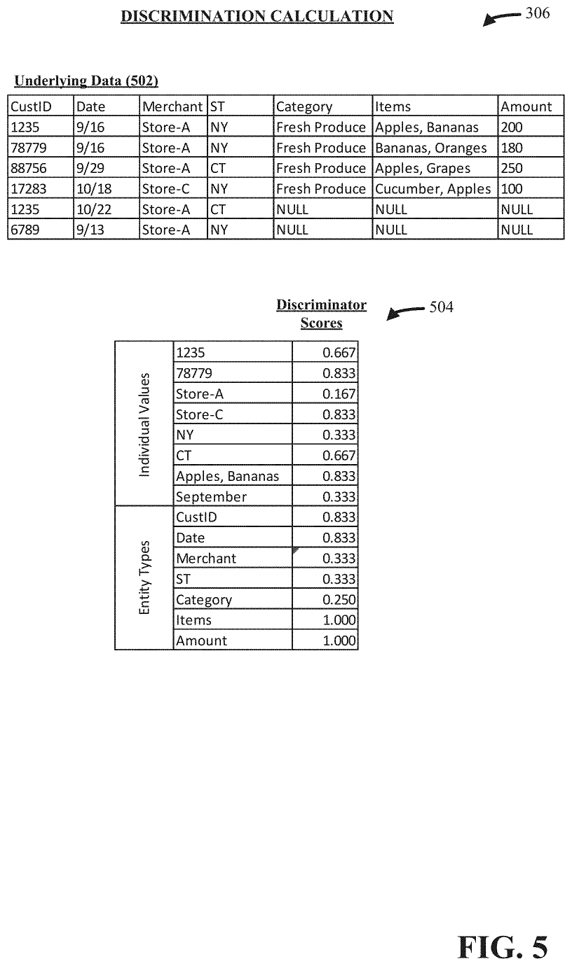

At FIGS. 3 and 5, the interpretation component 114 additionally and/or alternatively can perform, such as via the interpretation algorithm 119, a discrimination calculation 306 on the data underlying the query result from the respective knowledge database. An advantage of the interpretation of the underlying data comprising this discrimination calculation 306 is that the discrimination calculation 306 aids in identifying an entity type (column) or individual value (single box in the respective table) as distinguishing from other entity types or individual values. That is, this discrimination calculation 306 provides a normalized representation of the exclusivity of an individual value or of a column of the structured data underlying the query result. The discrimination calculation 306 is computed as an aggregated score for an entity type as compared to other entity types, or for an individual value as compared to other individual values in the same column or in different columns.

For a column (e.g., entity type), the resultant discriminator score is calculated as the following:

$$discriminator score = \frac{\# ( unique values in the column )}{\# ( total values in that column )} . \qquad Eq . 2$$

Thus, the discriminator score can vary from 1.000, meaning the entity type has high discrimination or exclusivity, to 1/n, meaning the entity type has low discrimination or exclusivity. In the case of a column, a discriminator score of 1/n with n being large would indicate all the values in the column being the same. To provide examples, at table 502, the Merchant column has two unique values (“Store-A” and “Store-C”), six total values, and thus a discriminator score at table 504 of 0.333. The Items column has four unique values, four total values, and thus a higher discriminator score of 1.000. It is noted that where one or more individual values in a column include multiple value portions, such as a date and a month (see, e.g., “ 9/16”), or such as a comma-delimited listing (see, e.g., “apples, bananas”), the entire individual value is considered as a non-divisible set, rather than as separate value portions. Further, it is noted that NULL values are not provided a discriminator score and do not count towards the #(total values in the column).

For an individual value in any one column, the resultant discriminator score is calculated as:

$$discriminator score = 1 - \frac{\# ( occurrences of the value in the column )}{\# ( total values in that column )} . \qquad Eq . 3$$

Thus, the discriminator score can vary from (n−1)/n, meaning the individual value has high exclusivity within the column, to 0.000, meaning the individual has low exclusivity in the column. For example, at table 504, the individual value “1235” appears twice in the CustID column and has a discriminator score of 0.667. Differently, the individual value “78779” appears once in the CustID column and thus has a discriminator score of 0.833. Individual values are considered as a non-divisible set, rather than as separate value portions. In one or more embodiments, the discrimination calculation 306 can be extended to determine a discriminator value of a sentence, such as a row of a respective table relative to all other rows in the respective table or set of data, or of an n-gram relative to all other n-grams in the respective table or set of data. For example, a discriminator score for a row or n-gram is the sum of the discriminator scores of the individual values contained in the row or n-gram. Looking to row number one (CustID “1235”) of the underlying data table 502 at FIG. 5, the discriminator score of the row is calculated as the sum of each of the individual discriminator scores 0.667, 0.667, 0.166, 0.333, 0, 0.750 and 0.750=3.333.

In one or more embodiments, an additional advantage of the discrimination calculation 306 can be the ability to use the resulting discriminator score(s) to complete a further pairwise similarity analysis 312, subset token matching analysis 314 and/or token importance analysis 316. One or more of these further analyses can provide one or more further bases 206 providing one or more additional reasons for the provision of the one or more query results 142. In one or more embodiments, an additional advantage of the influence calculation 304 can be the ability to use the resulting influence score(s) to complete a further pairwise similarity analysis 312, subset token matching analysis 314 and/or token importance analysis 316. One or more of these further analyses can provide one or more further bases 206 providing one or more additional reasons for the provision of the one or more query results 142.

Furthermore, an advantage of the interpretation of the underlying data comprising both the influence calculation 304 and the discrimination calculation 306 can be the identification of influential entities or entity types, having influence on the query results 142 and the identification an entity type (column) or individual value (single box in the respective table) as distinguishing from other entity types or individual values. Yet another advantage of employing together the influence calculation 304 and the discrimination calculation 306 can be the ability to use the resulting influence and discriminator scores to complete a further pairwise similarity analysis 312, subset token matching analysis 314 and/or token importance analysis 316. One or more of these further analyses can provide one or more further bases 206 providing one or more reasons for the provision of the one or more query results 142.

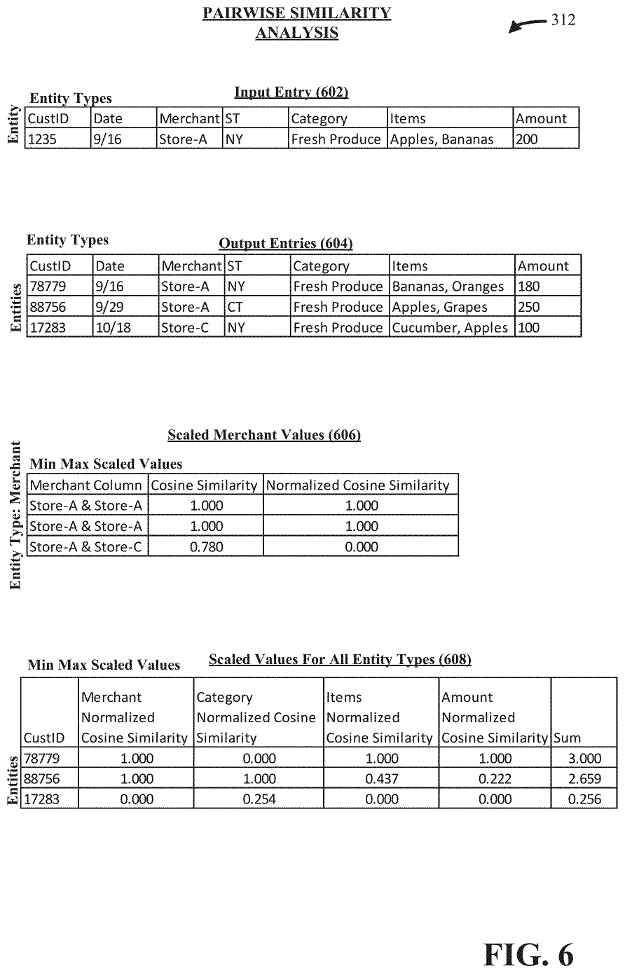

Looking to FIGS. 3 and 6, the interpretation component 114 can perform, such as via the interpretation algorithm 119, a pairwise similarity analysis 312 on the data underlying the query result from the respective knowledge database. Generally, an advantage of the pairwise similarity analysis 312 is the ability to compare an input entry with a plurality of output entries already present in the respective knowledge database to determine the closest output set to the input set. These output entries can be selected by the constituent 214, such as via the GUI 212 accessing the interpretation component 114 and/or the optimization component 118, and/or the output entries can be results from one or more of the other interpretation processes 120, such as the subset token matching analysis 314, to be described below.

Regarding the pairwise similarity analysis 312, where an input set of data is provided in a respective query, merely providing the closest output set can be only partially helpful to the constituent 214, such as a human user. Rather, via the pairwise similarity analysis 312, the underlying data can be analyzed to provide a normalized ranking of one or more output sets, such as ranged between most similar and least similar. These rankings can aid the constituent 214 in understanding why a particular entry prediction was returned as a query result over other particular entries in response to the respective query.

For use in calculating the rankings, all columns can be analyzed and/or a subset of columns can be analyzed. Columns analyzed can be automatically selected, such as being columns having top ranked influence and/or discriminator scores, and/or one or more columns analyzed can be selectively chosen, such as via the constituent 214, such as via the GUI 212 accessing the interpretation component 114 and/or the optimization component 118. In this manner, the constituent 214 can input influence score, discriminator score and/or influence and discriminator combined score thresholds for automatic selection of columns to be analyzed via the pairwise similarity analysis 312. With respect to FIG. 3, it will be appreciated that pairwise similarity analysis 312 can be performed with or without use of the influence and/or discriminator scores output from the respective influence calculation 304 and discrimination calculation 306.

Turning to an example similar to those presented in FIGS. 4 and 5, FIG. 6 illustrates an input entry of CustID “1235” at table 602 and a set of known output entries of CustIDs “78779”, “88756” and “17283” at a table 604. As shown at table 606, cosine similarity values can be provided between the individual values of each entity type of the input entry and the respective individual values of the entity types of each output entry. For example, cosine similarity values are calculated between Merchant “Store-A” of the input entry and each of the Merchants (“Store-A”, “Store-A” and “Store-C”, respectively) of each of the output entries. At table 606, a plurality of calculated cosine similarity values, calculated for a plurality of additional data columns, can be normalized relative to one another, such as being scaled using a min-max-scaler. As shown at table 608, the normalized values can allow for one or more comparisons to be made among the varying entity types comprised by the input and output entries. Further, the normalized values can allow for summation of normalized cosine similarity values per row or entry/entity, thus providing yet another mode of comparison among the plurality of output entries.

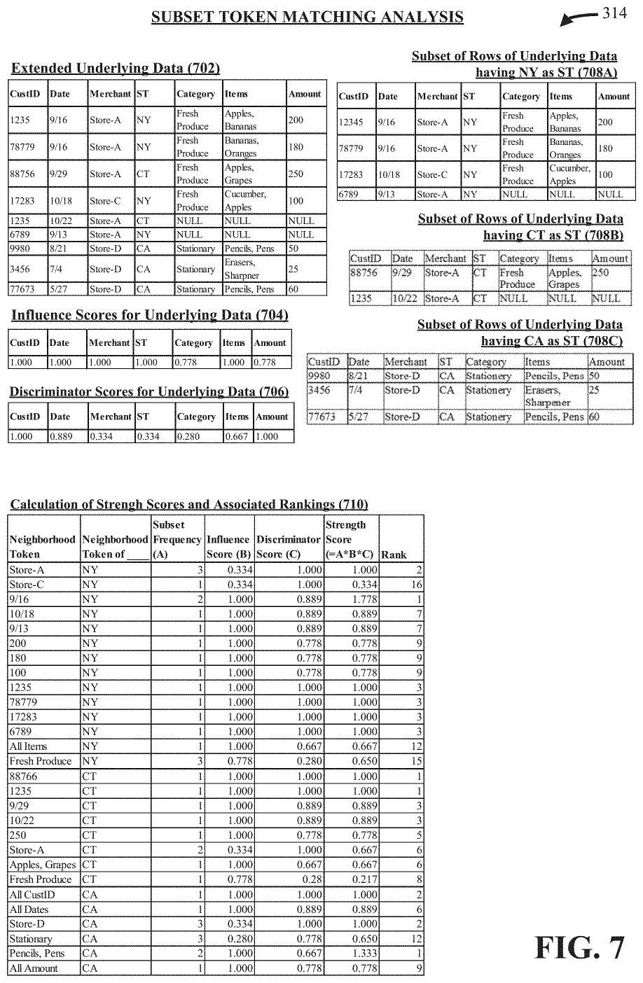

At FIGS. 3 and 7, the interpretation component 114 can perform, such as via the interpretation algorithm 119, a subset token matching analysis 314 on the data underlying the query result from the respective knowledge database. Generally, an advantage of this subset token matching analysis 314 is the ability to interpret one or more results from a query that compares individual values within a column or across columns relative to the respective query 128 token. Depending on the particular query, this query token can comprise a full entity, such as where the query is: “Find the most similar entity to CustID “1235”. Alternatively and/or additionally, the query token can comprise an n-gram or one or more individual values, such as where the query is: “Find the most similar Merchant to “Store-A”.

Further advantages are provided by the subset token matching analysis 314. For example, the subset token matching analysis 314 can aid in determining a subset (e.g., one or more) entries (e.g., rows) from the unstructured data comprising the respective query token. The subset token matching analysis 314 also can provide a ranking of neighborhood tokens of the query token. Neighborhood tokens can include all individual values in a row having a query token, where a collection of the rows having the query token can be defined as the relative subset. The highest ranked neighborhood tokens, or individual values of the respective knowledge base, are the most highly related to the query token.

To provide the ranking, a strength score can be calculated for each of the neighborhood tokens by utilizing the frequency of each respective neighborhood token in the subset in combination with the influence and discriminator scores of the respective column of each respective neighborhood token. The strength score can be calculated as indicated below at Eq. 4. The highest ranked results will have the highest strength scores and thus will have the most proximity to the query token.

strength score=subset frequency*influence score*discriminator score. Eq. 4

To provide further data useful to the constituent 214, additional results can be calculated, thus providing one or more additional ranking lists and allowing for comparison between the query token and the query results. That is, each of one or more of the top query results can be utilized as a faux “query token” to thereby calculate respective subset ranking lists and respective strength scores. Where the query token and a faux “query token” have common neighborhood tokens, the two strength scores calculated for each of these common neighborhood tokens can be utilized to provide a commonality score, provided below at Eq. 5. Common neighborhood tokens having the highest commonality scores are a leading basis for similarity between the query token and the faux “query token”. Further, a faux “query token” (or query result) lacking any common neighborhood tokens with the query token, and having fewer common neighborhood tokens with the query token, has lesser proximity to the query token.

$$commonality score = \begin{matrix}( \begin{matrix}common neighborhood token \\ strength result from query token subset\end{matrix} ) * \\ ( \begin{matrix}common neighborhood token \\ strength result from query result subset\end{matrix} ) .\end{matrix} \qquad Eq . 5$$

To provide an example FIG. 7 includes an extended underlying data table d at 702. In this example, a respective knowledge database, such as an AI-trained knowledge database, can be trained on the underlying data. A semantic query “Find the most similar State to NY” can be executed over the knowledge database, with the top two query results returned by CT and CA. To interpret and explain this result, the subset token matching analysis 314 can be used. Influence scores and discriminator scores for the columns of the underlying data can be calculated and are shown at tables 704 and 706, respectively. Next, tokens in the neighborhood of the input token can be determined and their frequency calculated. For example, subsetting the input rows that have NY as the ST, table 708A is provided.

Strength scores for neighborhood tokens (e.g., individual values) of NY can be calculated. Neighborhood tokens of NY include “Store-A”, “Store-C”, “Fresh Produce”, “ 9/16”, “ 10/18”, “ 9/13”, “200”, “180”, “100”, “1235”, “78779”, “17283”,“6789” and all Items individual values. The respective strength scores for these neighborhood tokens is demonstrated at table 710 and are ranked from highest to lowest. The individual values “ 9/16 ”, “Store-A” and “1235” have the closest proximity to the state NY, and thus have high proximity to the query token.

Ranked strength scores for neighborhood tokens of each of the query tokens CT and CA also can be calculated and also are provided at table 710, with a row subset for CT provided at table 708B and a row subset for CA provided at table 708C. Comparing the ranked orders of NY neighborhood tokens and CT neighborhood tokens, both “Store-A” and “Fresh Produce” are common individual values. Comparing the ranked orders of NY neighborhood tokens and CA neighborhood tokens, there are no common individual values. This aspect in itself provides at least one basis 206 for the higher query result ranking of CT than CA. Additionally, commonality values for the common individual values “Store-A” and “Fresh Produce” are 0.667 and 0.650, respectively. Accordingly, “Store-A” is explained as a basis 206 having the highest relation to similarity between the query token NY and the query result CT.

Next, the interpretation component 114 can perform a PMI analysis 318 to calculate a PMI for one or more entity types (columns) and/or for one or more individual values, such as all values, within one or more columns PMI analysis 318 in turn can be utilized for each of the token importance analysis 316 and an analogy interpretability 322 using the resultant PMI calculations. Calculation of PMI and interpretability of a related analogy using the resultant PMI calculations is appreciated as being understood by one having ordinary skill in the art and thus is not discussed herein, for sake of brevity.

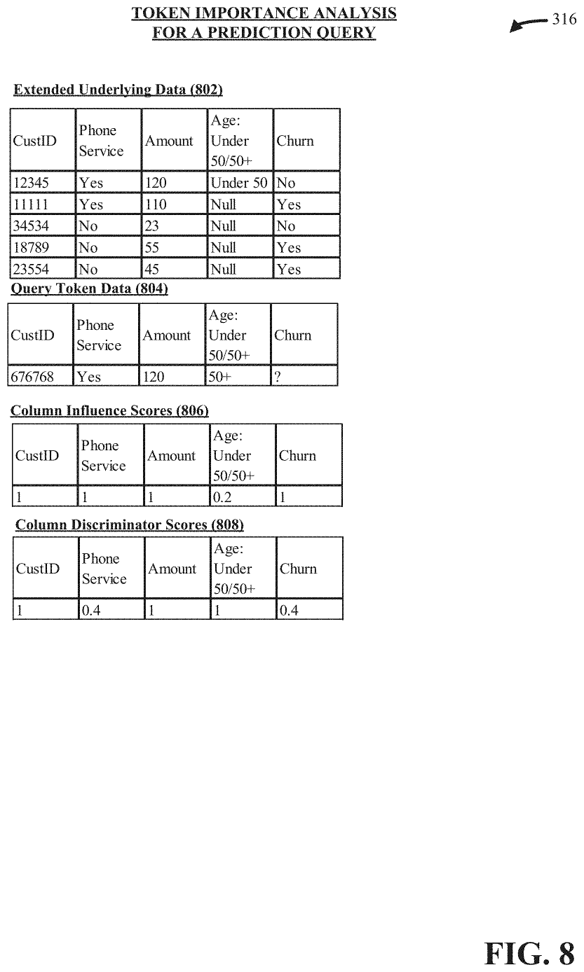

Additionally, referring to FIGS. 3 and 8, the interpretation component 114 can perform, such as via the interpretation algorithm 119, a token importance analysis 316 on the data underlying a prediction query result from the respective knowledge database. Generally, the influence score and/or the discriminator score can be used to identify columns of highest importance from the underlying data set, which total set is shown at table 802. These columns of importance, absent the column(s) for which the prediction was made, can be further analyzed via the token importance analysis 316.

In other embodiments, all columns can be analyzed and/or a different subset of columns can be analyzed. Columns analyzed can be automatically selected, such as being columns having top ranked influence and/or discriminator scores, and/or one or more columns for analysis can be selectively chosen, such as via the constituent 214, such as with the GUI 212. Further, in this manner, the constituent 214 can input influence score, discriminator score and/or influence and discriminator combined score thresholds for automatic selection of columns to be analyzed via the token importance analysis 316. With respect to FIG. 3, it will be appreciated that token importance analysis 316 can be performed with or without use of the influence and/or discriminator scores output from the respective influence calculation 304 and discrimination calculation 306.

With respect to the selected column(s) of importance, the interpretation algorithm 119 can use the individual values of the query token row for these columns and/or cosine similarity values for each of Churn “Yes” and Churn “No” to provide one or more votes for Churn “Yes” and Churn “No”. Vote strength can be provided by a related PMI analysis 318 between each of the chosen values from the query token row and Churn “Yes” and Churn “No”. That is, as shown at FIG. 3, it will be appreciated that PMI calculations can be utilized for the token importance analysis 316 for a prediction query.

To provide an example of a token importance analysis 316 for a prediction query, FIG. 8 provides an extended underlying data set at table 802. This extended underlying data set includes whether CustIDs have a Phone Service an Amount of the Phone Service (e.g., amount of a bill in USD), Age (Under 50/50+) of the CustIDs, and whether a customer will Churn (e.g., whether a customer will discontinue service). A “NULL” value in the Age (Under 50/50+) column represents an unknown. Over the underlying data, a prediction query is executed as to whether a query token (i.e., CustID “676768”) will churn. This query token is provided at table 804. In the case where the query result is YES, one or more bases 206 for this query result can be provided by the token importance analysis 316 for the respective prediction query.

Based on the column influence scores for the underlying data, provided at table 806, and on the column discriminator scores for the underlying data, provided at table 808, the columns with the highest influence and discriminator scores can be determined, absent the column for which the prediction was made. Here, the columns (e.g., entity types) of highest importance are CustID, Phone Service and Amount. The respective individual values from the query token for these columns (i.e., “676768”, “Yes” and “120”) can used by the interpretation algorithm 119, in combination with PMI calculations from a related PMI analysis 318 between each of these individual values from the query token row and Churn “Yes” and Churn “No”.

Additionally, a vector creation also can be performed for the query token row. That is, a vector that represents the row can be constructed using vectors that represent tokens in the row. The vectors for tokens within the row can be averaged by multiplying these vectors with inverse frequency and/or by another similar method.

Referring now back briefly to FIG. 2, the output component 116 can provide an output 208 to the constituent 214. The output 208 can be a representation of the basis 206, such as in a format usable by the constituent 214. For example, at the diagram 200, the output 208 can be displayed at the GUI 212 for the constituent 214. In an embodiment, a drop down menu or similar can be utilized, allowing for selection among bases 206 related to one or more of the interpretation processes 120. The GUI 212 can include access to descriptions of one or more of the interpretation processes. As mentioned above, in one or more embodiments, a user can select settings and/or thresholds relative to performance of one or more of the interpretation processes 120. In one or more embodiments, the GUI 212 can allow access to raw data from the knowledge database 130, which data can be searchable in one or more embodiments. Also as mentioned above, in one or more embodiments a user can input, view and/or modify one or more constituent-selectable inputs such as one or more parameters and/or thresholds usable in performance of the one or more interpretation processes 120.

Additionally and/or alternatively, the output 208 can be used by the optimization component 118. As illustrated, the constituent 214 can access the optimization component 118 via the GUI 212, to therefore provide modified and/or amended results that can be supplemental or replacements for one or more aspects of the query result 142. That is, based on the output 208 and the basis 206, the constituent 214, such as a human user, can determine adjust usage of underlying data such that subsequent query results 142 better fit a similar query 128 or query type of the query 128. Further, an additional advantage of the query interpretation system 102 is that the optimization component 118, such as via input from the constituent 214, can render these one or more adjustments and/or modifications as one or more optimizations 220 to the knowledge database 130 and/or to the query execution component 108.

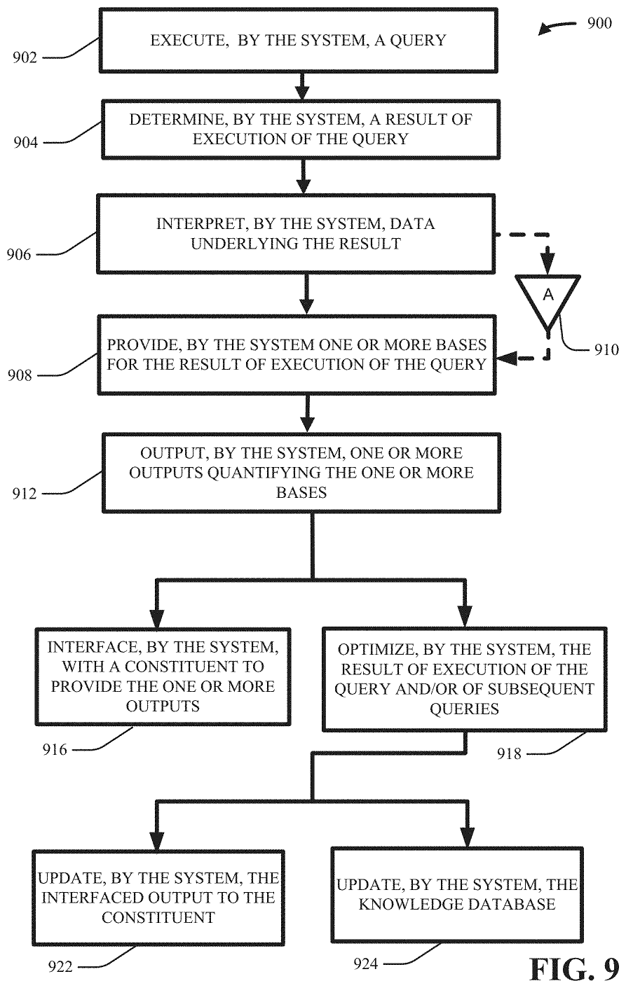

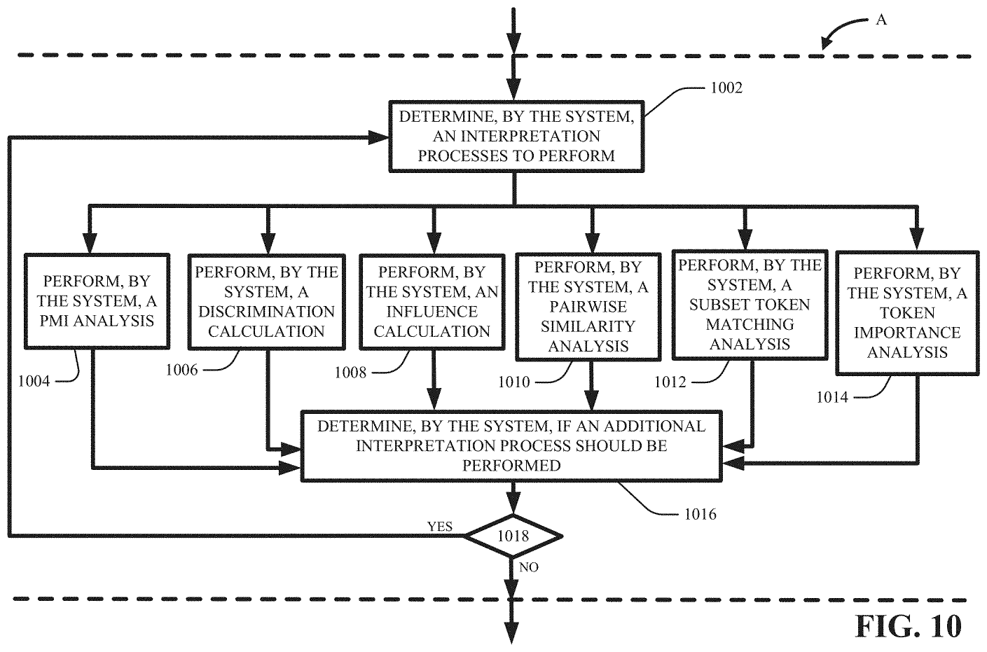

Referring now to FIGS. 9 and 10, these figures together illustrate a flow diagram of an example, non-limiting computer-implemented method 900 that can facilitate the interpretation of a result of execution of a query over a structured database, in accordance with one or more embodiments described herein. Repetitive description of like elements and/or processes employed in respective embodiments is omitted for sake of brevity.

Looking first to 902 at FIG. 9, the computer-implemented method 900 can comprise executing, by a system (e.g., via query result interpretation system 102 and/or query execution component 108) operatively coupled to a processor (e.g., processor 106, a quantum processor and/or like processor), of a query (e.g., query 128).

At 904, the computer-implemented method 900 can comprise determining, by the system (e.g., via query result interpretation system 102 and/or determination component 110) a result of execution of the query (e.g., query 128).

At 906, the computer-implemented method 900 can comprise interpreting, by the system (e.g., via query result interpretation system 102 and/or interpretation component 114) data underlying a query result (e.g., query result 142), such as using one or more interpretation processes (e.g., interpretation processes 120).

Turning to 908, the computer-implemented method 900 can comprise providing, by the system (e.g., via query result interpretation system 102 and/or interpretation component 114) one or more bases (e.g., bases 206) for the result of execution of the query (e.g., query result 142 of the query 128). These bases (e.g., bases 206) can be based upon one or more results of the interpretation processes (e.g., interpretation processes 120).

That is, looking briefly now to FIG. 10, one or more processes performed by the system (e.g., via query result interpretation system 102 and/or interpretation component 114) are illustrated. Together, theses one or more processes represent continuation triangle “A” illustrated at FIG. 9 as a process between blocks 906 and 908.

Turning first to 1002, the computer-implemented method 900 can comprise determining, by the system (e.g., via query result interpretation system 102, interpretation component 114 and/or interpretation algorithm 119) an interpretation process (e.g., an interpretation process 120) to perform. Once determined, at blocks 1004 to 1014, the computer-implemented method 900 can comprise performing, by the system (e.g., via query result interpretation system 102, interpretation component 114 and/or interpretation algorithm 119) the respective interpretation process. That is, the interpretation component 114 can execute the interpretation algorithm 119. For example, a PMI analysis (e.g., PMI analysis 318) can be performed at 1004, a discrimination calculation (e.g., discrimination calculation 306) can be performed at 1006, an influence calculation (e.g., influence calculation 304) can be performed at 1008, a pairwise similarity analysis (e.g., pairwise similarity analysis 312) can be performed at 1010, a subset token matching analysis (e.g., subset token matching analysis 314) can be performed at 1012 and/or a token importance analysis (e.g., token importance analysis 316) can be performed at 1014. Any one or more of these interpretation processes (e.g., interpretation processes 120) can be performed concurrently and/or subsequently where suitable. Where it is determined at block 1002 to perform an interpretation process using input from one or more of an influence calculation 304 or a discrimination calculation 306, and where such influence calculation 304 and/or discrimination calculation 306 has not yet been performed, the computer-implemented method 900 will be unable to perform and thus will move to block 1016 (such as via query result interpretation system 102, interpretation component 114 and/or interpretation algorithm 119). Likewise, after a respective interpretation process is performed, the computer-implemented method can move to block 1016.

At 1016, the computer-implemented method 900 can comprise determining, by the system (e.g., via query result interpretation system 102, interpretation component 114 and/or interpretation algorithm 119) if an additional interpretation process should be performed. The decision for this determination is made at decision block 1018. Where it is determined that an additional one or more interpretation processes should be performed, the computer-implemented method 900 can move back to determination block 1002.

That is, the interpretation component 114 can automatically or selectively perform one or more of the interpretation processes. One or more of the interpretation processes can be automatically and/or selectively repeated, such as over the same data and/or using different inputs. For example, a subset token matching analysis can be performed on columns (e.g., entity types) having been identified as the most influential and/or as the most discriminatory (e.g., via an influence calculation 304 and/or a discrimination calculation 306, respectively). Further, one or more interpretation processes can be repeated on the same data. An order of performance, listing of processes to perform, data on which to perform and/or other parameter can be automatically determined by the interpretation component 114 and/or selectively determined, such as via a constituent 214, such as via the GUI 212.

Alternatively, via the decision block 1018, where it is determined that no additional interpretation process should be performed, the computer-implemented method 900 can move from continuation triangle “A” to block 908 at FIG. 9.

Next, referring back to FIG. 9, at 912, the computer-implemented method 900 can comprise outputting, by the system (e.g., via query result interpretation system 102 and/or output component 116) one or more outputs (e.g., outputs 208) quantifying the one or more bases (e.g., bases 206).

At 916, the computer-implemented method 900 can comprise interfacing, by the system (e.g., via query result interpretation system 102 and/or output component 116) with a constituent (e.g., constituent 214) to provide the one or more outputs (e.g., outputs 208). For example, the outputs (e.g., outputs 208) can be provided to a constituent (e.g., the constituent 214) such as via a GUI (e.g., GUI 212).

Additionally and/or alternatively, at 918, the computer-implemented method 900 can comprise optimizing, by the system (e.g., via query result interpretation system 102 and/or optimization component 118) the result (e.g., query result 142) of the respective query (e.g., query 128) and/or of subsequent queries, such as in the form of one or more optimizations (e.g., optimizations 220). As discussed above, this optimization can be automatic and/or selectively applied. Where this optimization results in a change to the query result (e.g., query results 142), at 922, the computer-implemented method 900 can comprise updating, by the system (e.g., via query result interpretation system 102, output component 116 and/or optimization component 118). Additionally and/or alternatively, at 924, the computer-implemented method 900 can comprise updating, by the system (e.g., via query result interpretation system 102 and/or optimization component 118) a respective knowledge database (e.g., the knowledge database 130) in regards to the one or more optimizations (e.g., optimizations 220). It will be appreciated that the processes of the above-described blocks 916, 918, 922 and 924 can be performed concurrently and/or subsequently, where suitable.

In the above examples, it should be appreciated that the query result interpretation system 102 can reduce and/or eliminate human effort, assist in optimization of the query result interpretation system 102 itself and/or improve upon query results provided as compared to present systems. In the examples above, it should be appreciated that human effort can be lessened in that query result interpretation system 102 can automatically query a structured database, can do so relative to continually updated data and relationships comprised by the structured database, and/or can automatically review and/or analyze the voluminous amounts of new content continually added to public and non-public databases. Likewise, in the example above, it should be appreciated that query result interpretation system 102 can improve upon query results provided by known systems by providing increased interpretability of query results, through automatically providing insight to the user/constituent via an open box approach, that is, by determining one or more bases for results of execution of a query.

For example, the query result interpretation system 102 provides a new approach driven by previously unincorporated query result interpretability. Not least in one or more professional service domains, such as medicine and/or finance, the query result interpretation system 102 can provide a new approach to enable greater precision and/or accuracy of services provided. That is, professionals in these domains can employ query result interpretation system 102 to improve upon unsupported prediction results by providing increased result interpretation. In many cases, professionals in these domains can further employ query result interpretation system 102 to optimize performance of the query result interpretation itself 102, such as allowing for optimization of the search query, the query results, future queries and/or results of future queries. Examples of these optimizations include, but are in no way limited to, providing entity resolution for an incorrect value of the query result 142, providing a query result 142 more closely related to a particular query 128 or query type, determining key database statistics providing greater contribution to results than other database statistics and/or modifying how one or more data aspects (e.g., entities 134, entity types 136 and/or entity relationships 138) of a respective knowledge database 130, are utilized to provide one or more query results 142.

Query result interpretation system 102 can enable technical improvements to a processing unit associated with query result interpretation system 102. For example, through performing the above-described interpretation of query results, an advantage can be that the query result interpretation system 102 can enable optimization of the query results and/or the query itself through selected modifications to query execution and/or query result interpretation operations. Accordingly, by this example, the query result interpretation system 102 can thereby facilitate improved performance, improved efficiency and/or reduced computational cost associated with a processing unit (e.g., processor 106) employing the query result interpretation system 102.

A practical application, and thus advantage, of the query result interpretation system 102 is thus that it can be implemented in one or more domains to enable greater precision and/or accuracy of services provided. For example, a practical application, and thus advantage, of the query result interpretation system 102 is that it can be implemented in one or more professional domains, such as related to medicine and/or finance, such that a professional therein can employ query result interpretation system 102 to optimize performance of the query result interpretation itself 102, such as allowing for optimization of the search query, the query results, future queries and/or results of future queries.

Query result interpretation system 102 can employ hardware and/or software to solve problems that are highly technical in nature (e.g., related to interpreting data underlying query results, transforming that data and/or providing the data in a format usable by a user/constituent), that are not abstract, and that cannot be performed as a set of mental acts by a human For example, a human, or even thousands of humans, cannot efficiently, accurately and/or effectively interpret data underlying query results and provide one or more bases for the query results.

In one or more embodiments, one or more of the processes described herein can be performed by one or more specialized computers (e.g., a specialized processing unit, a specialized classical computer, a specialized quantum computer and/or another type of specialized computer) to execute defined tasks related to the one or more technologies identified above. Query result interpretation system 102 and/or components thereof, can be employed to solve new problems that arise through advancements in technologies mentioned above, employment of quantum computing systems, cloud computing systems, computer architecture and/or another technology.

It is to be appreciated that query result interpretation system 102 can utilize one or more combinations of electrical components, mechanical components and/or circuitry that cannot be replicated in the mind of a human and/or performed by a human, as the one or more operations that can be executed by query result interpretation system 102 and/or components thereof as described herein are operations that are greater than the capability of a human mind. For instance, the amount of data processed, the speed of processing the data and/or the types of data processed by query result interpretation system 102 over a certain period of time can be greater, faster and/or different than the amount, speed and/or data type that can be processed by a human mind over the same period of time.

According to several embodiments, query result interpretation system 102 also can be fully operational towards performing one or more other functions (e.g., fully powered on, fully executed and/or another function) while also performing the one or more operations described herein. It should be appreciated that the simultaneous multi-operational execution is beyond the capability of a human mind. It should also be appreciated that query result interpretation system 102 can include information that is impossible to obtain manually by an entity/constituent, such as a human user. For example, the type, amount and/or variety of information included in and/or employed by query result interpretation system 102, determination component 110, interpretation component 114 and/or output component 116 can be more complex than information obtained manually by an entity, such as a human user.

For simplicity of explanation, the computer-implemented methodologies are depicted and described as a series of acts. It is to be understood and appreciated that the subject innovation is not limited by the acts illustrated and/or by the order of acts, for example acts can occur in one or more orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

In order to provide additional context for one or more embodiments described herein, FIG. 12 and the following discussion are intended to provide a brief, general description of a suitable operating environment 1200 in which the one or more embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures and/or the like, that perform particular tasks and/or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

One or more of the illustrated embodiments described herein also can be practiced in a distributed computing environment where certain tasks are performed by remote processing devices that are linked through a communications network. In a distributed computing environment, program modules can be located both in local and remote memory storage devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, but not limitation, communication media can include wired media, such as a wired network, direct-wired connection and/or wireless media such as acoustic, RF, infrared and/or other wireless media.

With reference again to FIG. 11, the example operating environment 1100 for implementing one or more embodiments of the aspects described herein includes a computer 1102, the computer 1102 including a processing unit 1104, a system memory 1106 and/or a system bus 1108. The system bus 1108 can couple system components including, but not limited to, the system memory 1106 to the processing unit 1104. The processing unit 1104 can be any of various commercially available processors. Dual microprocessors and/or other multi-processor architectures can be employed as the processing unit 1104.

The system bus 1108 can be any of several types of bus structure that can further interconnect to a memory bus (with or without a memory controller), a peripheral bus and/or a local bus using any of a variety of commercially available bus architectures. The system memory 1106 can include ROM 1110 and/or RAM 1112. A basic input/output system (BIOS) can be stored in a non-volatile memory such as ROM, erasable programmable read only memory (EPROM) and/or EEPROM, which BIOS contains the basic routines that help to transfer information among elements within the computer 1102, such as during startup. The RAM 1112 can also include a high-speed RAM, such as static RAM for caching data.

The computer 1102 further can include an internal hard disk drive (HDD) 1114 (e.g., EIDE, SATA), one or more external storage devices 1116 (e.g., a magnetic floppy disk drive (FDD), a memory stick or flash drive reader, a memory card reader and/or the like) and/or a drive 1120, e.g., such as a solid state drive or an optical disk drive, which can read or write from a disk 1122, such as a CD-ROM disc, a DVD, a BD and/or the like. Additionally and/or alternatively, where a solid state drive is involved, disk 1122 could not be included, unless separate. While the internal HDD 1114 is illustrated as located within the computer 1102, the internal HDD 1114 can also be configured for external use in a suitable chassis (not shown). Additionally, while not shown in operating environment 1100, a solid state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The HDD interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more applications 1132, other program modules 1134 and/or program data 1136. All or portions of the operating system, applications, modules and/or data can also be cached in the RAM 1112. The systems and methods described herein can be implemented utilizing various commercially available operating systems and/or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In a related embodiment, operating system 1130 can comprise one virtual machine (VM) of multiple VMs hosted at computer 1102. Furthermore, operating system 1130 can provide runtime environments, such as the JAVA runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and/or settings for an application.

Further, computer 1102 can be enabled with a security module, such as a trusted processing module (TPM). For instance, with a TPM, boot components hash next in time boot components and wait for a match of results to secured values before loading a next boot component. This process can take place at any layer in the code execution stack of computer 1102, e.g., applied at application execution level and/or at operating system (OS) kernel level, thereby enabling security at any level of code execution.

A user entity can enter commands and information into the computer 1102 through one or more wired/wireless input devices, e.g., a keyboard 1138, a touch screen 1140 and/or a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices can be connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface and/or the like.

A monitor 1146 or other type of display device can be also connected to the system bus 1108 via an interface, such as a video adapter 1148. In addition to the monitor 1146, a computer typically includes other peripheral output devices (not shown), such as speakers, printers and/or the like.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device and/or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 and/or can be connected to a communications server on the WAN 1156 via other means for establishing communications over the WAN 1156, such as by way of the Internet. The modem 1160, which can be internal or external and a wired and/or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link among the computers can be used.

When used in either a LAN or WAN networking environment, the computer 1102 can access cloud storage systems or other network-based storage systems in addition to, or in place of, external storage devices 1116 as described above, such as but not limited to, a network virtual machine providing one or more aspects of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 11511 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

Referring now to FIG. 12, an illustrative cloud computing environment 1250 is depicted. As shown, cloud computing environment 1250 includes one or more cloud computing nodes 1210 with which local computing devices used by cloud consumers, such as, for example, personal digital assistant (PDA) or cellular telephone 1254A, desktop computer 1254B, laptop computer 1254C and/or automobile computer system 1254N can communicate. Although not illustrated in FIG. 12, cloud computing nodes 1210 can further comprise a quantum platform (e.g., quantum computer, quantum hardware, quantum software and/or the like) with which local computing devices used by cloud consumers can communicate. Cloud computing nodes 1210 can communicate with one another. They can be grouped (not shown) physically or virtually, in one or more networks, such as Private, Community, Public, or Hybrid clouds as described hereinabove, or a combination thereof. This allows cloud computing environment 1250 to offer infrastructure, platforms and/or software as services for which a cloud consumer does not need to maintain resources on a local computing device. It is understood that the types of computing devices 1254A-N shown in FIG. 12 are intended to be illustrative only and that cloud computing nodes 1210 and cloud computing environment 1250 can communicate with any type of computerized device over any type of network and/or network addressable connection (e.g., using a web browser).

Referring now to FIG. 13, a set of functional abstraction layers is shown, such as provided by cloud computing environment 1250 (FIG. 12). It should be understood in advance that the components, layers and functions shown in FIG. 13 are intended to be illustrative only and embodiments described herein are not limited thereto. As depicted, the following layers and corresponding functions are provided:

Hardware and software layer 1360 can include hardware and software components. Examples of hardware components include: mainframes 1361; RISC (Reduced Instruction Set Computer) architecture-based servers 1362; servers 1363; blade servers 1364; storage devices 1365; and networks and networking components 1366. In one or more embodiments, software components can include network application server software 1367, quantum platform routing software 1368 and/or quantum software (not illustrated in FIG. 13).

Virtualization layer 1370 can provide an abstraction layer from which the following examples of virtual entities can be provided: virtual servers 1371; virtual storage 1372; virtual networks 1373, including virtual private networks; virtual applications and/or operating systems 1374; and/or virtual clients 1375.

In one example, management layer 1380 can provide the functions described below. Resource provisioning 1381 can provide dynamic procurement of computing resources and other resources that can be utilized to perform tasks within the cloud computing environment. Metering and Pricing 1382 can provide cost tracking as resources are utilized within the cloud computing environment, and billing or invoicing for consumption of these resources. In one example, these resources can include application software licenses. Security can provide identity verification for cloud consumers and tasks, as well as protection for data and other resources. User (or constituent) portal 1383 can provide access to the cloud computing environment for consumers and system administrators. Service level management 1384 can provide cloud computing resource allocation and management such that required service levels are met. Service Level Agreement (SLA) planning and fulfillment 1385 can provide pre-arrangement for, and procurement of, cloud computing resources for which a future requirement is anticipated in accordance with an SLA.

Workloads layer 1390 can provide examples of functionality for which the cloud computing environment can be utilized. Non-limiting examples of workloads and functions which can be provided from this layer include: mapping and navigation 1391; software development and lifecycle management 1392; virtual classroom education delivery 1393; data analytics processing 1394; transaction processing 1395; and/or application transformation software 1396.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on the user's computer, partly on the user's computer, as a stand-alone software package, partly on the user's computer and/or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that the one or more embodiments herein also can be implemented in combination with other program modules. Generally, program modules include routines, programs, components, data structures and/or the like that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics and/or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments provided herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system, comprising:
a memory that stores computer executable components; and
a processor that executes the computer executable components stored in the memory, wherein the computer executable components comprise:
a determination component that determines a result of execution of a query over a structured database; and
an interpretation component that interprets data underlying the result of execution of the query to determine one or more bases for the query; and
wherein the interpretation of the data comprises calculation of a degree of uniqueness of a first aspect of structured data of the database as distinguished relative to one or more other aspects of structured data of the database.

2. The system of claim 1, wherein the structured database comprises a typed relational database including information regarding a plurality of entity types.

3. The system of claim 2, wherein the interpretation of the data comprises inter- and intra-entity type analysis.

4. The system of claim 1, wherein the query is a semantic query.

5. (canceled)

6. The system of claim 1, wherein the interpretation of the data comprises calculation of a degree of influence of an aspect of structured data of the database relative to the result of execution of the query.

7. The system of claim 1, further comprising an output component that provides feedback depicting the one or more bases as normalized numerical values.

8. A computer-implemented method, comprising:
determining, by a system operatively coupled to the processor, a result of execution of a query over a structured database; and
interpreting, by the system, data underlying the result of execution of the query to determine one or more bases that the result is provided in response to the query; and
wherein the interpreting, by the system, comprises calculating, by the system, a degree of uniqueness of a first aspect of structured data of the database as distinguished relative to one or more other aspects of structured data of the database.

9. The computer-implemented method of claim 8, wherein the database comprises a typed relational database including information regarding a plurality of entity types.

10. The computer-implemented method of claim 9, wherein the interpreting, by the system, comprises inter- and intra-entity type analysis.

11. The computer-implemented method of claim 8, wherein the query is a semantic query.

12. (canceled)

13. The computer-implemented method of claim 8, wherein the interpreting, by the system, comprises calculating, by the system, a degree of influence of an aspect of structured data of the database relative to the result of execution of the query.

14. The computer-implemented method of claim 8, further comprising outputting feedback depicting the one or more bases as normalized numerical values.

15. A computer program product facilitating interpretation of a result of a query over a structured database, the computer program product comprising a computer readable storage medium having program instructions embodied therewith, the program instructions executable by a processor to cause the processor to:
determine, by the processor, the result of execution of the query of the structured database; and
interpret, by the processor, data underlying the result of execution of the query to determine one or more bases that the result is provided in response to the query; and
wherein causing the processor to interpret, by the processor, comprises causing the processor to calculate, by the processor, a degree of uniqueness of a first aspect of structured data of the database as distinguished relative to one or more other aspects of structured data of the database.

16. The computer program product of claim 15, wherein the structured database comprises a typed relational database including information regarding a plurality of entity types.

17. The computer program product of claim 16, wherein causing the processor to interpret, by the processor, comprises inter- and intra-entity type analysis.

18. The computer program product of claim 15, wherein the query is a semantic query.

19. (canceled)

20. The computer program product of claim 15, wherein causing the processor to interpret, by the processor, comprises causing the processor to calculate, by the processor, a degree of influence of an aspect of structured data of the database relative to the result of execution of the query.

21. A system, comprising:
a memory that stores computer executable components; and
a processor that executes the computer executable components stored in the memory, wherein the computer executable components comprise:
a determination component that determines a result of execution of a query over a structured database; and
an interpretation component that calculates one or more numerical values for one or more aspects of the database, which one or more aspects have respective distinct relations to the result.

22. The system of claim 21, wherein the one or more numerical values are ranked relative to one or more other numerical values calculated for one or more other aspects of the database.

23. A system, comprising:
a memory that stores computer executable components; and
a processor that executes the computer executable components stored in the memory, wherein the computer executable components comprise:
a determination component that determines a result of execution of a query over a database; and
an interpretation component that interprets data underlying a result of execution of a query over the database to determine a basis for the result;
and an output component that outputs the basis as a numerical value, and wherein the numerical value represents a degree of influence or a degree of uniqueness of an aspect of data of the database relative to the result or to one or more other aspects of data of the database in respect to provision of the result.

24-25. (canceled)
